(19) United States
(12) Patent Application Publication
(10) Pub. No.: US 2010/0254000 A1
(43) Pub. Date: Oct. 7, 2010

(54) MIRROR CASCADE FOR BUNDLING A PLURALITY OF LIGHT SOURCES AND A LASER-SCANNING MICROSCOPE

(76) Inventors: Dieter HUHSE, Berlin (DE); Dieter SCHAU, Lehesten (DE); Stefan WILHELM, Jena (DE)

Correspondence Address: JACOBSON HOLMAN PLLC, 400 SEVENTH STREET N.W., SUITE 600, WASHINGTON, DC, 20004, US

(21) Appl. No.: 12/752,362

(22) Filed: Apr. 1, 2010

Related U.S. Application Data
(63) Continuation of application No. PCT/EP2008/007687, filed on Sep. 16, 2000.

(30) Foreign Application Priority Data
Oct. 2, 2007 (DE) 10 2007 047 183.3

(51) Int. Cl. G02B 21/06; G02B 27/14

(52) U.S. Cl. 359/385; 359/629

(57) ABSTRACT

A mirror cascade for the adjustment-free bundling of a plurality of light sources to be coupled into the beam path of a laser scanning microscope, comprising a beam combiner housing in which the mirror cascade is located, wherein the beam combiner housing can be either mounted directly on a scanning head of a laser scanning microscope and has a direct optical connection thereto or can be mounted on a microscope housing and has an optical connection thereto or is directly arranged in the scanning head. The invention further relates to a laser scanning microscope with such a mirror cascade.

### CROSS-REFERENCE TO RELATED APPLICATIONS

The present patent application is a continuation of International application No. PCT/EP2008/007687, filed Sep. 16, 2008, published in German, which is based on, and claims priority from, German Application No. 10 2007 047 183.3, filed Oct. 2, 2007, both of which are incorporated herein by reference in their entireties.

### BACKGROUND OF THE INVENTION

1. Field of the Invention

The invention relates to a laser-scanning microscope, as described, for example, in DE 19702753 A1 (U.S. Pat. No. 6,631,226).

2. Description of Related Art

Including Information Disclosed Under 37 CFR §§1.97 and 37 CFR 1.98

So-called laser modules are now used in most confocal systems. Laser modules are understood to mean functional units that co-linearly combine several lasers of different wavelengths into one beam and transport the combined radiation to a scan head via a fiber-optic light guide.

There is also the possibility of individually modulating the radiation or attenuating it and selecting individual laser lines from the mixture. Beam combining is then accomplished via mirrors and dichroic splitters in the open beam. For this purpose, all components are mounted on a common base plate and with a fixed position as stable as possible relative to each other.

Other solutions propose individual fiber coupling of the laser and beam combining via a tubular combining unit, at whose output there is a fiber coupling for guiding the light to the scan head as shown in U.S. Pat. No. 6,222,961. The '961 patent relates to a point light source for a laser-scanning microscope. At least two lasers with different wavelengths may be coupled in the microscope. To combine the advantages of a multiline laser with those of the use of several independent single-line lasers, the point light source is characterized by at least two laser light sources the beam of which are fed into a beam combiner, and by an optical fiber which leads directly or indirectly from the beam combiner to the microscope.

However, solutions are also known that provide for individual fiber coupling of the laser to a scan head as shown in JP 2003270543. JP 2003270543 relates to a confocal optical scanner capable of emitting excitation light of multiple linear laser beams by synthesizing a plurality of the laser beams varying in wavelengths with simple, low-cost construction and low cost without using a spot light source. The confocal optical scanner has a confocal scanning mechanism for optically scanning a sample of an optical microscope by making the laser beam mounted on the optical microscope incident on the optical microscope. The scanner has means for guiding a plurality of the laser beams varying in wavelengths and is provided with a laser beam synthesizing mechanism for synthesizing a plurality of the laser beams and making the laser beam incident as the excitation light on the confocal scanning mechanism and the confocal scanning mechanism within the same container.

Errors caused by misalignments of laser beams caused by shock during transportation and temperature changes, as well as cyclical temperature changes during the use of a system by a customer, are ordinarily seen for the open beam solution. Such errors require readjustment by a service technician, both during setup of the instrument and over the duration of its use.

The laser modules are generally large and heavy because it is necessary that the components be assembled with a fixed reference to each other and be mounted on a stable granite slab or steel frame. The costs for reliable transport of a system are correspondingly high. The limited flexibility with reference to setup at the customer's location, because of large space requirements, is also significant. Another drawback is the limited flexibility with reference to the integration of new light sources and the great amount of time needed for adding predefined light sources in an existing layout (for example, by retrofitting).

### BRIEF SUMMARY OF THE INVENTION

The invention therefore concerns a fiber-coupled, open beam assembly for implementation of illumination of laser-scanning microscopes with individual fiber coupling of the laser to a scan head, beam combining, beam modulation, and beam attenuation. A significant advantage is achieved with reference to freedom from adjustment, both in system integration and setup of the instrument by the customer and over the operating life of the system. Because of this, the subsequent costs are kept low and startup of the instrument can be reduced to a simple “plug and play.” Freedom from adjustment means that overlapping of individual fiber inputs with reference to location and angle is adjusted only once, i.e., during assembly of the beam combining group, and otherwise remains free from requiring adjustment, both after transport and under the operating conditions at the customer's location.

### BRIEF DESCRIPTION OF THE SEVERAL VIEWS OF THE DRAWINGS

FIG. 1 is a schematic diagram of a scan head embodying the present invention.

FIG. 2 is a schematic diagram showing laser coupling in accordance with the present invention.

FIG. 3 is a schematic drawing showing a mirror cascade in accordance with the present invention.

FIG. 4a is a schematic diagram of a beam combiner with direct coupling into a microscope.

FIG. 4b is a schematic diagram of a beam combiner showing laser coupling from several sides.

FIG. 5 is a schematic diagram of a beam combiner housing with an AOTF in accordance with the present invention.

FIG. 6 is a schematic diagram of a first embodiment of an internal fiber and AOTF connection in a scan head housing.

FIG. 7 is a schematic diagram of a second embodiment of an internal fiber and AOTF connection in a scan head housing.

FIG. 8 is a schematic diagram of a third embodiment of an internal fiber and AOTF connection in a scan head housing.

FIG. 9 is a schematic diagram of a fourth embodiment of an internal fiber and AOTF connection in a scan head housing.

FIG. 10 is a schematic diagram showing the beam combiner with an additional unoccupied coupling port for an additional laser.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

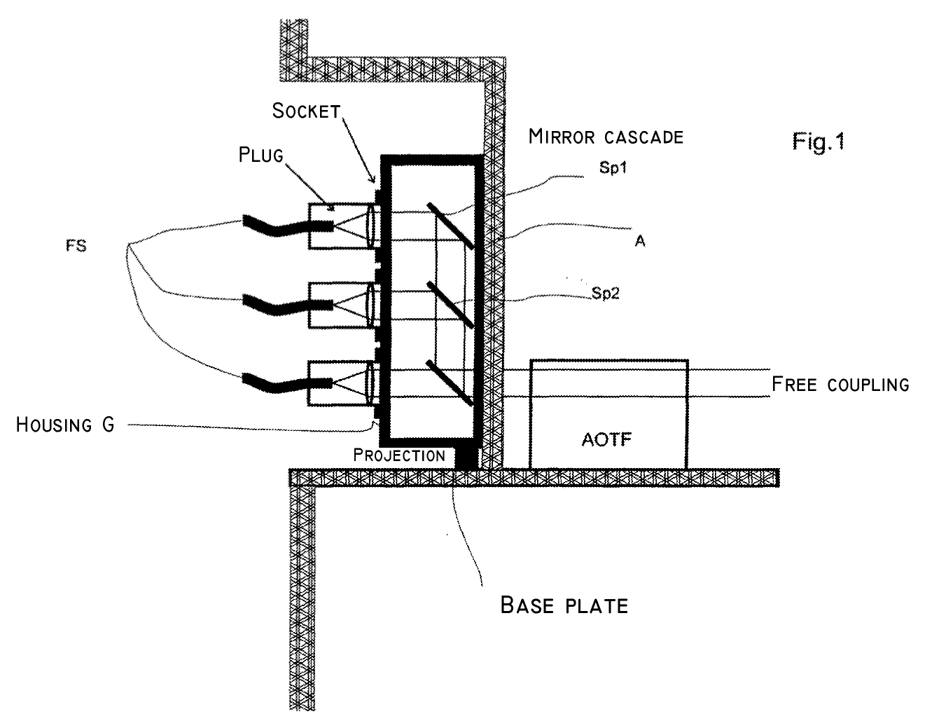

With reference to FIG. 1, the outer wall A of a scan head is shown, on which, via a number of projections (only one of which is shown), a housing G is provided for a beam-combining unit SV with a mirror cascade SP 1, 2, and so on. The housing G has sockets to accommodate plugs, which couple optical fibers FS to housing G. The optic fibers FS originate from different light sources. After the mirror cascade, the combined beam is conveyed to a microscope, preferably via an AOTF.

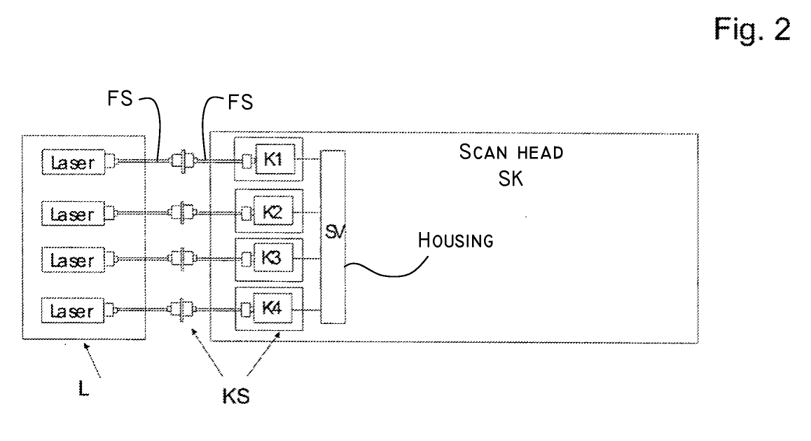

With reference to FIG. 2, a plurality of lasers L are coupled individually into the beam path of the LSM in scan head SK via optical fibers FS and coupling ports KS, which are connected to a beam combining unit SV in the scan head itself or to the beam combining unit SV via optical fibers FS, which can be situated outside the scan head.

The beam combining unit SV, as stated, has a housing and can therefore be designed to be very compact and stable, which saves adjustment costs. An AOTF for wavelength selection and individual control of intensity could also advantageously be integrated in the beam combining unit SV.

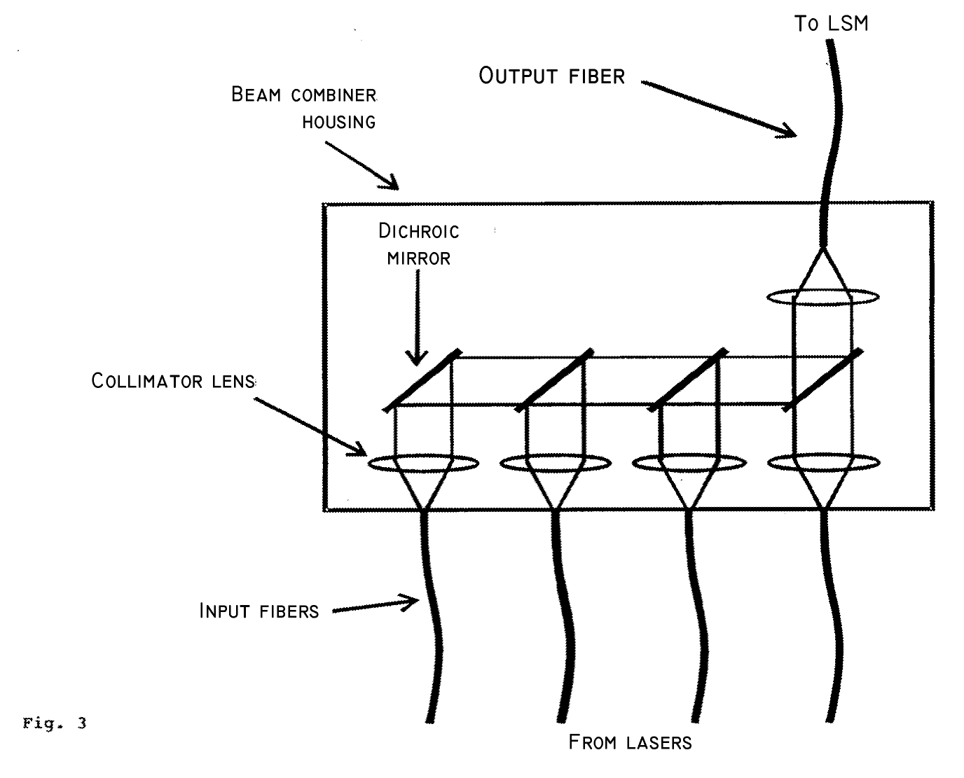

FIG. 3 shows a mirror cascade of dichroic mirrors in the housing, in which several input lasers are coupled in via optical fibers and collimator lenses arranged in the housing interior. An output optical fiber following the last mirror of the mirror cascade serves for flexible integration in the illumination beam path of the LSM. The output optical fiber serves not only to integrate beam combining optically in the scan head (the entire beam combining group is situated in or on the scan head) in an advantageous variant, but advantageously also serves for an increase in stability. The increase in stability is obtained, owing to the fact that misalignments that result in a location and/or angle error are converted to intensity errors, because of the resulting coupling losses.

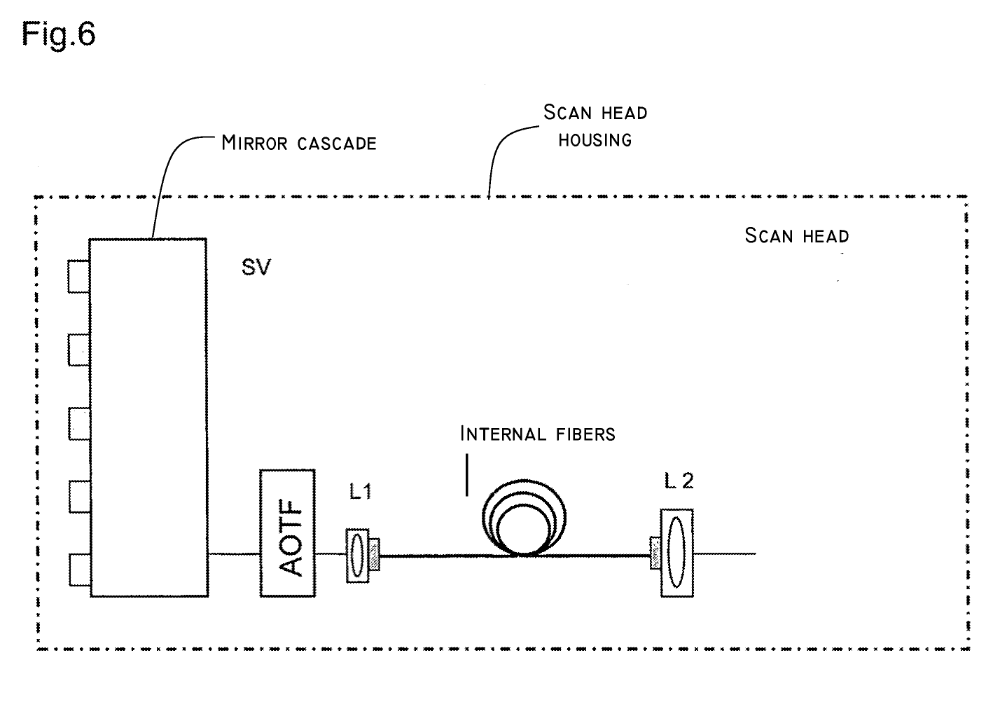

A tolerable angle error of 100 μrad in an open beam design is converted by the correction fiber (that is, the output optical fiber) into an intensity error of about 5%. Moreover, the deviations of individual coupling ports are not added to each other, as in the open beam solution, but all coupling ports exhibit an individual interaction upon coupling with the correction fiber. The same applies for lateral misalignments. A parallel misalignment of about 50 μm can be accepted in the open beam solution, based on the following telescope (beam expander) (as described below in connection with FIG. 6). With reference to the correction fiber, this value is at least twice as high, if a roughly 5% intensity loss is permitted. The employed correction fiber is advantageously a monomode (also known as “single-mode”), broadband, polarization-retaining fiber. As an alternative, any other energy conductor that has these properties, for example, plastic fibers, waveguides etched in silicon, etc., can also be used.

If a correction fiber is used, it can be characterized by a circular or kidney shape, in order to achieve better mode filtration and therefore further increase the quality of the output signal.

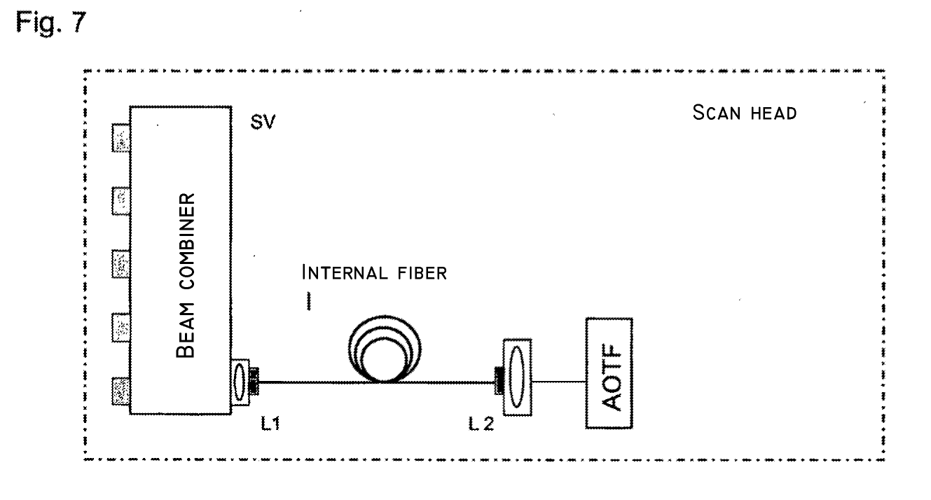

The use of a correction fiber also opens up instrument capabilities that permit complete decoupling of the illumination unit integrated in the scan head from the rest of the beam path (flexible instrument design, compact design)—in connection with which, FIGS. 7-10 and the corresponding description are referred to.

An important aspect is that the beam combining unit represents a preadjusted assembly, which need not be further adjusted during later steps of system integration and during instrument installation at the customer's location or, if lasers are added/retrofitted in the field, at the customer's location. With appropriate precise layout of the fiber plug-in connectors, the beam overlap is retained during loosening and connection of plug-in connectors.

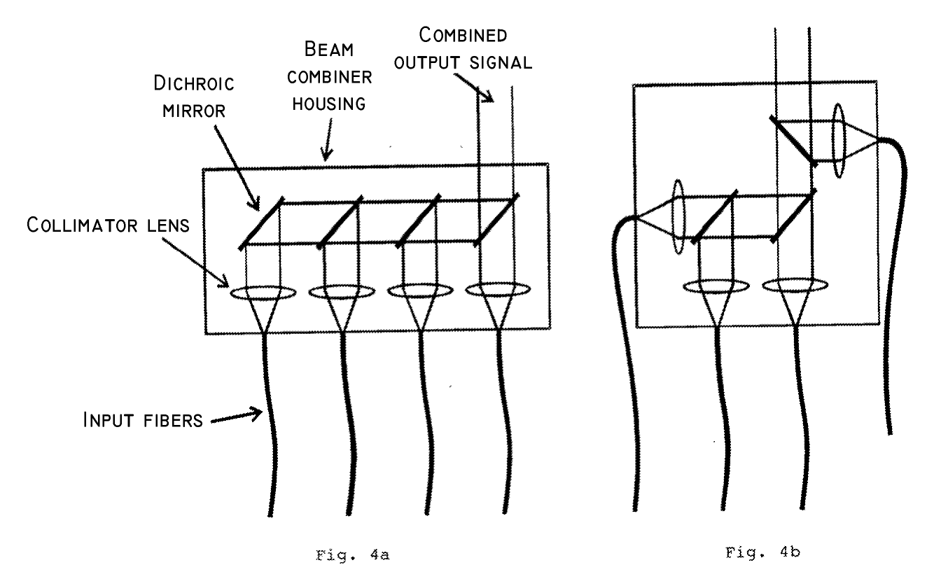

A beam combiner is shown in FIG. 4a, in which the combined output beam is coupled directly into the microscope (scan head) as an output beam (from the beam combiner).

The lasers are coupled from several sides (of the beam combiner housing) in FIG. 4b, in order to achieve a more compact, symmetric, and therefore more stable design. Coupling can also occur in several planes, for example, perpendicular and parallel to the plane of FIG. 4b into the beam combiner.

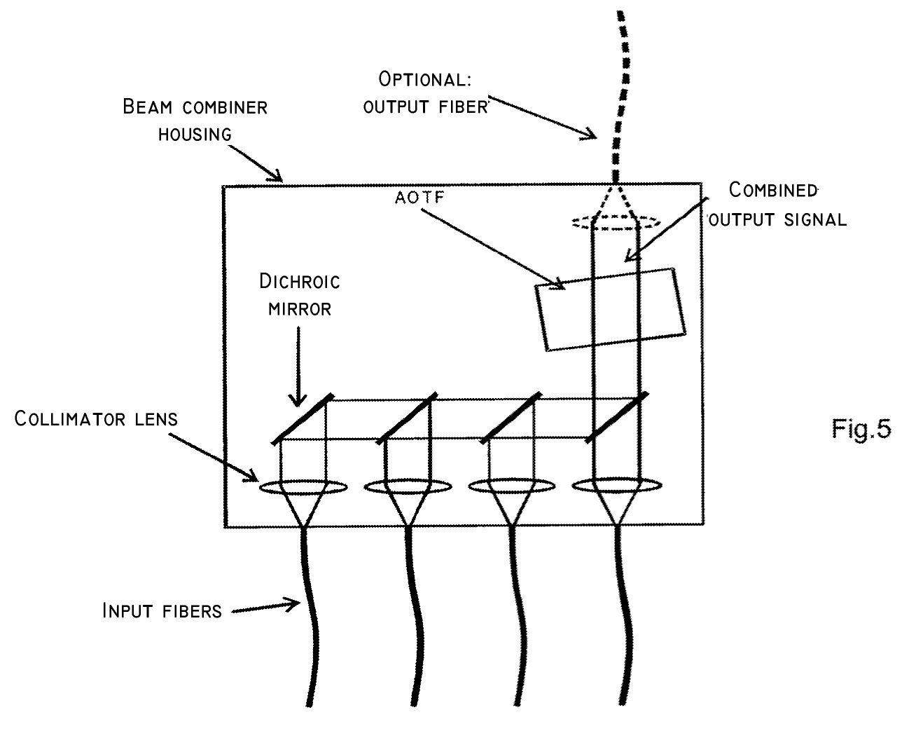

With reference to FIG. 5, in this variant, as already mentioned, an AOTF is arranged in the beam combiner housing. In order to place the temperature-sensitive AOTF in the most favorable location in the scan head, the input and the output of the AOTF can be connected to an optical fiber. In this way, the AOTF can be mounted in any position in the housing. The optical fiber on the output side can be brought smoothly to the optical axis of the overall system.

In contrast to the most of the previously used constructions, both the output fiber and the AOTF can be constructed in the range from 400 nm to 640 nm and therefore cover the entire visible spectral range. Spectral coverage beyond this range is also possible with appropriate components.

FIG. 6 shows, following the beam combining unit SV in the scan head in accordance with FIGS. 2 and 3, an internal correction fiber (located following the AOTF) for conversion of location and angle errors to intensity errors. The lens L2 can have a different focal length than lens L1 and therefore cooperates with it (lens L1) to act as a telescope (beam expander). All components (mirror cascade, AOTF, fiber with coupling-in and coupling-out optics) are attached separately in the housing/scan head.

FIG. 7 shows in the scan head, following the beam combining unit SV, the internal correction fiber (located before the AOTF) for conversion of location and angle errors to intensity errors. In contrast to the configuration of FIG. 1, the fiber is directly connected to the mirror cascade, so that greater stability is achieved for coupling. The lens L2 can again have a different focal length than lens L1 and therefore cooperate with it (lens L1) to act as a telescope (beam expander). The mirror cascade and fiber form one unit, following which the lens L2 is connected.

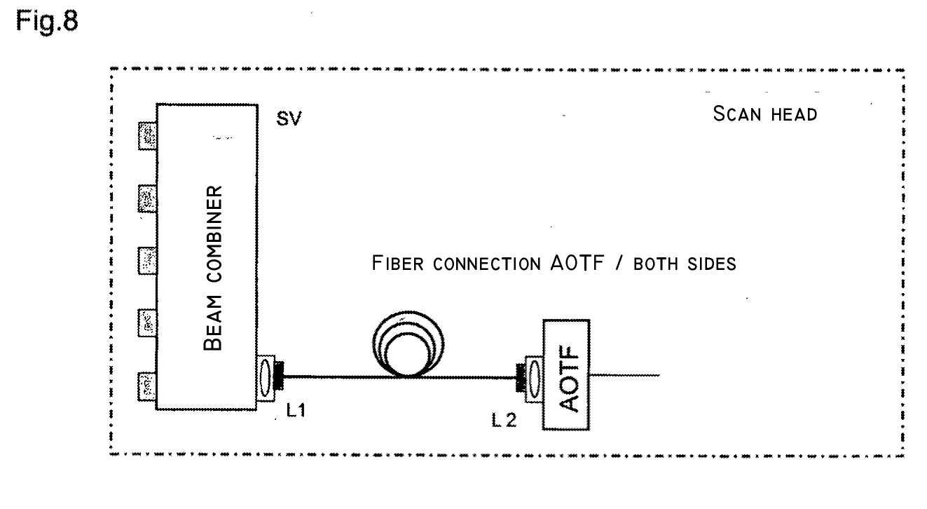

FIG. 8 shows in the scan head, the internal correction fiber for conversion of location and angle errors to intensity errors. In contrast to the configuration of FIG. 2, the optical fiber is again directly connected to the mirror cascade, and also directly connected to the AOTF. Lens L2 has the same focal length as lens L1, so that a 1:1 transformation of the beam diameter occurs from the mirror cascade to the AOTF. The connection to the mirror cascade and/or AOTF can be implemented as a so-called “pigtail” (not releasable), so that greater long-term stability and more compact design is achieved for coupling (precision plug-in connection free of adjustment requires more room (design space)); and can also, in principle, be detachably mounted on lens L1 (mirror cascade) and/or lens L2 (input AOTF).

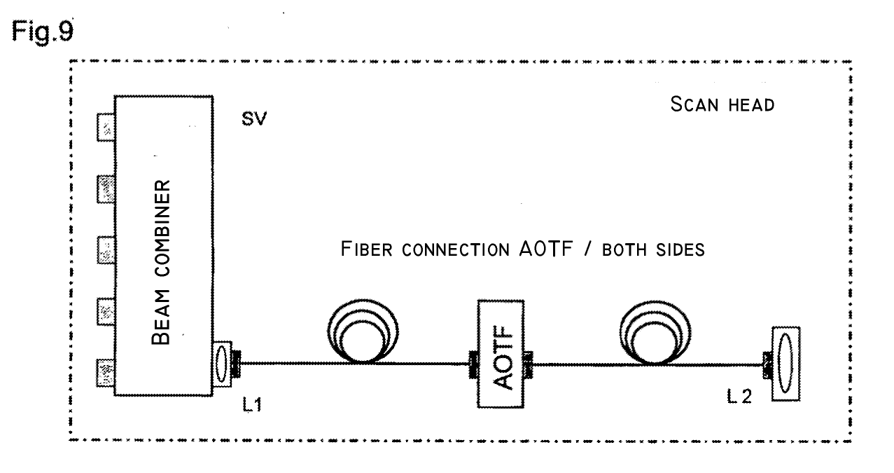

FIG. 9 shows, in the scan head, the internal correction fiber for conversion of location and angle errors to intensity errors. In contrast to the configuration of FIG. 8, an optical fiber is firmly connected to the system at the output of the AOTF. The lens L2 can have a different focal length than lens L1 and therefore cooperates with it (lens L1) to act as a telescope (beam expander). The connection to the mirror cascade and/or AOTF can again be implemented as a so-called “pigtail” (not releasable), so that greater long-term stability and a more compact design is achieved for coupling (adjustment-free precision plug-in connection requires more room (design space)); and can also, in principle, be detachably mounted on lens L1 (mirror cascade) and/or lens L2 (input AOTF).

Alternatively, the separation ports can be laid out adjustment-free using precise/high-precision plugs, which are releasable.

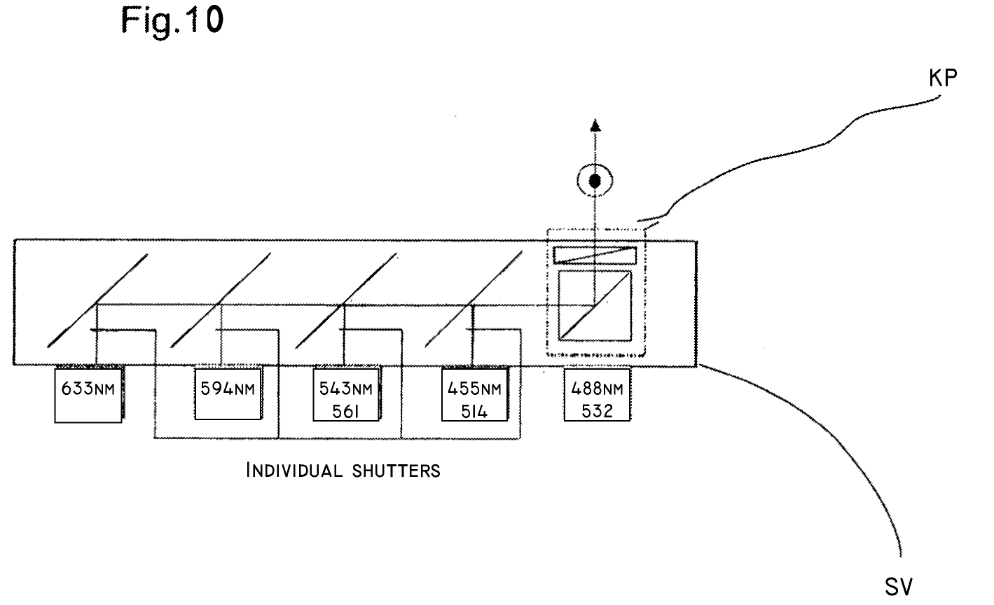

With reference to FIG. 10, the beam combiner SV can have an additional unoccupied coupling port KP for an additional laser.

This can be provided both as an open beam coupling (i.e., without collimator lens) and as a fiber coupling. Beam combining of the lasers coupled via the unoccupied coupling port can then be implemented conventionally using a beam splitter with dichroic layers or a polarizing beam splitter, and therefore independently of wavelength.

At the output of the mirror cascade in this case, a switchable lambda/2 plate is provided, in order to obtain the same polarization direction for reflected and transmitted beams at the output of the mirror cascade (essential for subsequent coupling into the AOTF). Via integration of such an unoccupied coupling port, the flexibility of laser coupling is significantly increased; for example, a combination of laser sources of equal wavelength with different power (bleaching laser, manipulation laser) from different modules via this unit is conceivable, or also broadband-emitting laser light sources or broadband tunable laser light sources can additionally be coupled.

A filter wheel can optionally be incorporated between the beam combiner and AOTF and correction fiber and in beam combining, in order to deliberately select only one emission line in multicolor lasers (for example, Ar lasers) (not shown). Shutters to suppress unused lasers can also be mounted individually for each port (at the input) and/or for all ports together at the output. These can be both safety shutters (laser safety) and functional shutters. The purpose of these shutters is complete masking of residual light in appropriate critical applications, in which suppression with an AOTF is not sufficient (for example, in fluorescence correlation spectroscopy (FCS)). An essential element of this solution, among other things, is the highly accurate and reproducible plug-in of individual fiber-coupled lasers to the beam combiner unit.

The required precision plug-in can be achieved in three possible ways:
a) Use of high-precision fiber plug-in connectors with separate collimator lens. The sockets on the beam combiner and the fiber plug-in itself must be designed so precisely in this case, that light output at the fiber plug-in connector during each plug-in is situated almost always at the same location and the beam emerges with the same angle—the accuracy is then predetermined by the requirements of the additional beam path following the beam combiner. In order to keep collimation of the laser radiation in a defined range, the axial position of the fiber to the collimation optics must also be precise and reproducible accordingly.
b) Use of precise fiber plug-in connectors with integrated collimator—similar to a), but the position of the fiber relative to the collimator is fixed. Through the collimator integrated in the plug, only the angle of the plug to the optical axis need be maintained very accurately and the location (lateral and axial position) is relatively non-critical, because of the parallel beam path following the collimator.
c) Fiber-fiber plug-in connector outside the actual beam combination. The optical fiber is firmly connected to the mirror cascade or plugged in only once during first assembly. Beam combining is then carried out either by adjustment of the mirror cascade or by moving the layering of the fiber end. The free end of the fiber is provided with a precision fiber plug-in connector (for example, FC-PC), so that the fiber-coupled laser that is provided with a plug-in fiber connector of similar type can be connected to the fiber via a fiber socket provided as an intermediate piece firmly mounted on the beam combiner (direct contact of both fiber cores).

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically disclosed.

What is claimed is:

1. Apparatus for adjustment-free combining of several light sources to be coupled into the beam path of a laser-scanning microscope, comprising:
a mirror cascade;
a beam combiner housing in which the mirror cascade is situated, the beam combiner housing being one of:
mounted directly on a scan head of the laser scanning microscope and having a direct optical connection to the scan head,
mounted on the housing of the laser scanning microscope and having an optical connection thereto, and
arranged in a scan head of the laser scanning microscope.

2. The apparatus of claim 1, wherein the beam combiner housing has coupling ports for the coupling of at least one optical fiber for coupling of illumination light.

3. The apparatus of claim 2, wherein the coupling ports are situated in the beam combiner housing.

4. The apparatus of claim 2, wherein the coupling ports are situated in the wall of the beam combiner housing.

5. The apparatus of claim 1, wherein the beam combiner housing has coupling ports for coupling out of at least one optical fiber for coupling out of the illumination light.

6. The apparatus of one of claim 1, wherein the beam combiner housing includes at least one unoccupied, expandable coupling port for the coupling of an additional laser.

7. The apparatus of claim 1, further comprising an AOTF in the beam path, arranged following the beam combiner housing.

8. The apparatus of claim 1, further comprising an AOTF in the beam path, arranged following the beam combiner.

9. The apparatus of claim 8, in which the beam combiner and the AOTF are arranged in the scan head.

10. The apparatus of claim 8, in which the AOTF is arranged in the beam combiner housing.

11. The apparatus of claim 8, further comprising optical fibers arranged at least one of before and following the AOTF.

12. The apparatus of claim 11, wherein the optical fibers are broadband monomode fibers.

13. A laser-scanning microscope comprising a scan head and the apparatus of claim 1.

14. The laser-scanning microscope of claim 13, further comprising at least one optical fiber for coupling of the illumination light, and
wherein the beam combiner housing has coupling ports for the coupling of the at least one optical fiber for coupling of the illumination light.

15. The laser-scanning microscope of claim 14, wherein the coupling ports are situated in the beam combiner housing.

16. The laser-scanning microscope of claim 14, wherein the coupling ports are situated in the wall of the beam combiner housing.

17. The laser-scanning microscope of claim 13, further comprising at least one optical fiber for coupling out of the illumination light,
wherein the beam combiner housing has coupling ports for coupling out of the at least one optical fiber for coupling out of the illumination light.

18. The laser-scanning microscope of claim 13, wherein the beam combiner housing includes at least one free expandable coupling port for the coupling of an additional laser.

19. The laser-scanning microscope of claim 13, further comprising an AOTF in the beam path, arranged following the beam combiner housing.

20. The apparatus of claim 13, further comprising an AOTF in the beam path, arranged following the beam combiner.

21. The laser-scanning microscope of claim 20, in which the beam combiner and the AOTF are arranged in the scan head.

22. The apparatus of claim 20, in which the AOTF is arranged in the beam combiner housing.

23. The laser-scanning microscope of claim 20, further comprising optical fibers arranged at least one of before and following the AOTF.

24. The laser-scanning microscope of claim 22, wherein the optical fibers are broadband monomode fibers.
